(19) United States
(12) Patent Application Publication
(10) Pub. No.: US 2025/0283305 A1
(43) Pub. Date: Sep. 11, 2025

(54) WORK MACHINE AND OPERATION SYSTEM FOR WORK MACHINE

(71) Applicant: SUMITOMO CONSTRUCTION MACHINERY CO., LTD., Tokyo (JP)

(72) Inventors: Takashi YAMAMOTO, Chiba (JP); Yuiki MATSUHASHI, Chiba (JP); Kazuma SHINKAI, Chiba (JP)

(21) Appl. No.: 19/063,865

(22) Filed: Feb. 26, 2025

(30) Foreign Application Priority Data
Mar. 11, 2024 (JP) 2024-037458

(51) Int. Cl. E02F 9/26; E02F 3/32; E02F 9/20; E02F 9/22; G10L 25/78

(52) U.S. Cl. CPC E02F 9/261; G10L 25/78; E02F 3/32; E02F 9/205; E02F 9/2203; E02F 9/2285; E02F 9/2292; E02F 9/2296

(57) ABSTRACT

A work machine includes a lower traveling body; an upper slewing body slewably mounted on the lower traveling body; an external microphone configured to collect sound around a work machine; an internal speaker configured to output sound to an operator of the work machine; an information transmission device configured to enable a worker around the work machine to recognize whether or not a voice of the worker has reached the operator of the work machine; and a processor, and a memory storing instructions that cause the processor to execute a process. The process includes collecting, by the external microphone, sound around the work machine; outputting, by the internal speaker, the sound to the operator of the work machine; and enabling, by the information transmission device, the worker around the work machine to recognize whether or not a voice of the worker has reached the operator of the work machine.

### CROSS-REFERENCE TO RELATED APPLICATIONS

This application is based upon and claims priority to Japanese Patent Application No. 2024-037458, filed on Mar. 11, 2024, the entire contents of which are incorporated herein by reference.

### BACKGROUND

### 1. Technical Field

The present disclosure relates to a work machine and an operation system for the work machine.

### 2. Description of Related Art

In the related art technologies, an excavator including a microphone for collecting a voice of a worker around the excavator is known.

### SUMMARY

According to an embodiment of the present disclosure, a work machine is provided. The work machine includes:
a lower traveling body;
an upper slewing body slewably mounted on the lower traveling body;
an external microphone configured to collect sound around a work machine;
an internal speaker configured to output sound to an operator of the work machine;
an information transmission device configured to enable a worker around the work machine to recognize whether or not a voice of the worker has reached the operator of the work machine; and
a processor, and a memory storing instructions that cause the processor to execute a process, wherein the process includes
collecting, by the external microphone, sound around the work machine;
outputting, by the internal speaker, the sound to the operator of the work machine; and
enabling, by the information transmission device, the worker around the work machine to recognize whether or not a voice of the worker has reached the operator of the work machine.

### BRIEF DESCRIPTION OF THE DRAWINGS

FIG. 1 is a side view of a work machine according to an embodiment of the present disclosure.

FIG. 2 is a top view of the work machine illustrated in FIG. 1.

FIG. 3 is a view illustrating examples of configurations of an external sound collection device and an information transmission device attached to the work machine illustrated in FIG. 1.

FIG. 4 is a diagram schematically illustrating a configuration example of the work machine illustrated in FIG. 1.

FIG. 5 is a top view illustrating an inside of a cabin of the work machine illustrated in FIG. 1.

FIG. 6 is a perspective view illustrating the work machine boarded by an operator and a worker around the work machine.

FIG. 7 is a flowchart illustrating an example of a sequence of an information transmission process.

FIG. 8 is a flowchart illustrating an example of a proceed of a sound transmission process.

FIG. 9 is a flowchart illustrating an example of a proceed of a conversation notification process.

FIG. 10 is a top view of a work machine illustrating another configuration example of a work machine according to the embodiment of the present disclosure.

FIG. 11 is a schematic view illustrating a configuration example of an operation system according to an embodiment of the present disclosure.

### DETAILED DESCRIPTION

However, in the above-described related art technologies, the worker around the excavator serving as a work machine may not be able to determine whether or not his/her voice has reached the operator of the excavator.

Therefore, it is desirable for the worker to recognize that the voice of the worker has reached the operator of the work machine such as the excavator.

The work machine described above enables the worker to recognize that the voice of the worker around the work machine has reached the operator of the work machine.

Hereinafter, embodiments of the present disclosure will be described with reference to the accompanying drawings. The embodiments described below are merely examples and do not limit the invention. All features and combinations thereof in the embodiments of the present disclosure are not necessarily essential to the invention. In the drawings, the same or corresponding components are denoted by the same or corresponding reference numerals, and redundant description thereof may be omitted.

The work machine 100 according to the embodiment of the present disclosure is an excavator. The work machine 100 may be a machine other than the excavator, such as a crane, an asphalt finisher, or a forklift. In the illustrated example, the excavator as the work machine 100 is a digging machine including the bucket 6 as an end attachment, but may be an application machine such as a forestry machine including an end attachment other than the bucket 6.

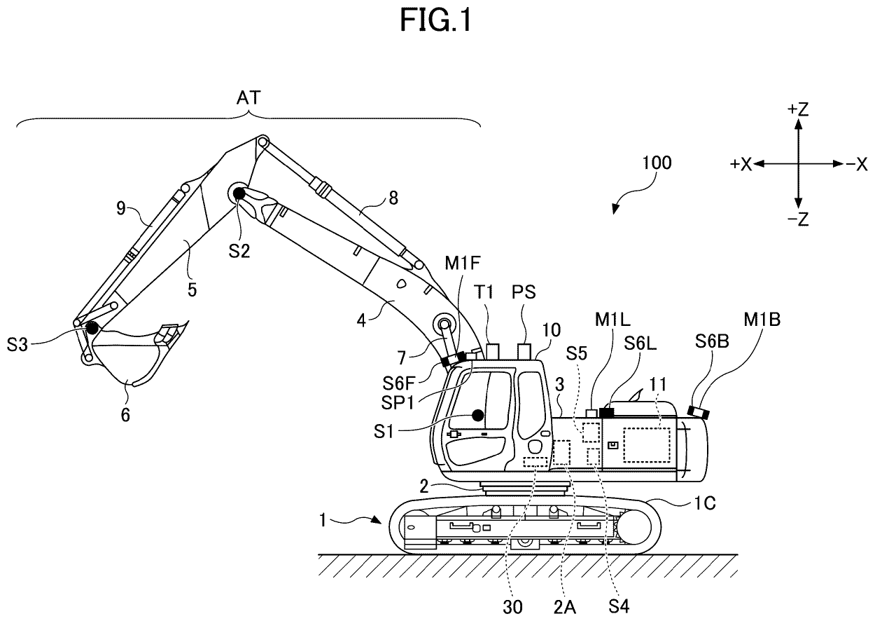

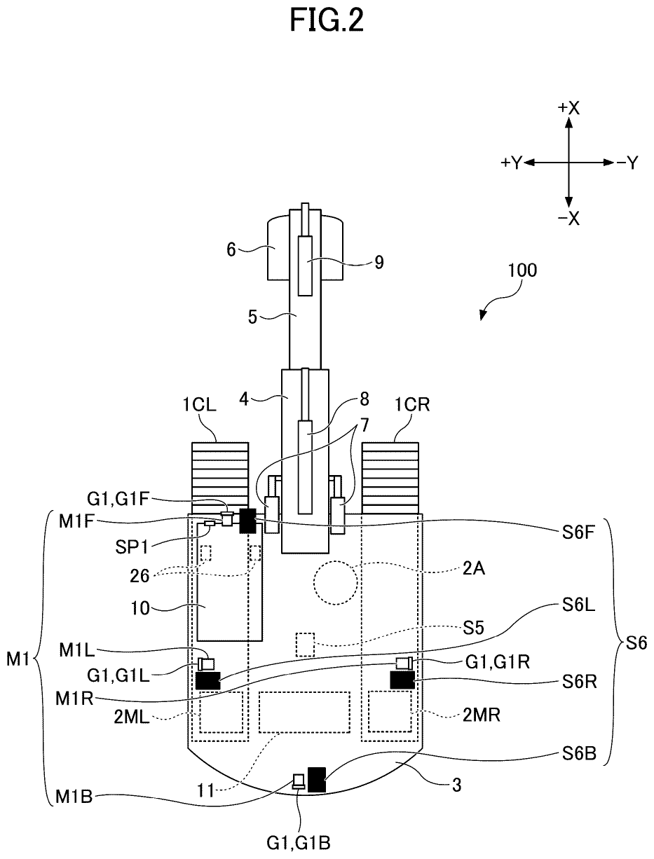

First, an overview of the work machine 100 will be described with reference to FIGS. 1 and 2. FIG. 1 is a side view of the work machine 100, and FIG. 2 is a top view of the work machine 100.

In FIG. 1, +X represents one direction of the X-axis constituting the three dimensional orthogonal coordinate system, and −X represents the other direction of the X-axis. In FIG. 2, +Y represents one direction of the Y axis constituting the three dimensional orthogonal coordinate system, and −Y represents the other direction of the Y axis. In FIG. 1, +Z represents one direction of the Z-axis constituting the three dimensional orthogonal coordinate system, and −Z represents the other direction of the Z-axis. In FIG. 1, the +X side of the work machine 100 corresponds to the front side of the work machine 100, and the −X side of the work machine 100 corresponds to the rear side of the work machine 100. The +Y side of the work machine 100 corresponds to the left side of the work machine 100, and the −Y side of the work machine 100 corresponds to the right side of the work machine 100. The +Z side of the work machine 100 corresponds to the upper side of the work machine 100, and the −Z side of the work machine 100 corresponds to the lower side of the work machine 100. The same applies to the other drawings.

The work machine 100 includes a lower traveling body 1, an upper slewing body 3 that is slewably mounted on the lower traveling body 1 via a slewing mechanism 2, an attachment AT for performing various kinds of work, and a cabin 10. The cabin 10 is also called an operation cabin or a cab. The front side of the work machine 100 (upper slewing body 3) corresponds to a side on which the attachment AT is attached to the upper slewing body 3 when the work machine 100 is viewed from directly above along the slewing axis of the upper slewing body 3. The left side, the right side, and the rear side of the work machine 100 (upper slewing body 3) correspond to the left side, the right side, and the rear side, respectively, as viewed from the operator seated in an operator's seat in the cabin 10.

The lower traveling body 1 includes, for example, a pair of left and right crawlers 1C. In particular, the crawlers 1C include a left crawler 1CL and a right crawler 1CR. The left crawler 1CL is driven by a left traveling hydraulic motor 2ML, and the right crawler 1CR is driven by a right traveling hydraulic motor 2MR. The left traveling hydraulic motor 2ML is a traveling driving part that drives the left crawler 1CL as a driven part, and can rotate the left crawler 1CL. The right traveling hydraulic motor 2MR is a traveling driving part that drives the right crawler 1CR as a driven part, and can rotate the right crawler 1CR. The travel driving part may be an electric motor.

The upper slewing body 3 slews with respect to the lower traveling body 1 by the slewing mechanism 2 being driven by the slewing hydraulic motor 2A. The slewing hydraulic motor 2A is a slewing driving unit that drives the upper slewing body 3 as a driven part, and can change the direction of the upper slewing body 3. The slewing driving part may be an electric motor.

A boom 4 is rotatably attached to the center of the front portion of the upper slewing body 3, an arm 5 is rotatably attached to the distal end of the boom 4, and a bucket 6 is rotatably attached to the distal end of the arm 5. In the illustrated example, the boom 4, the arm 5, and the bucket 6 constitute an excavation attachment which is an example of the attachment AT. The boom 4, the arm 5, and the bucket 6 are driven by a boom cylinder 7, an arm cylinder 8, and a bucket cylinder 9, respectively.

The bucket 6 is an example of a work tool (end attachment). The bucket 6 is used for, for example, excavation work. Instead of the bucket 6, another work tool may be attached to the distal end of the arm 5 depending on the work content or the like. The other work tool may be another type of bucket, such as a large bucket, a slope bucket, or a dredging bucket. The other work tool may be a work tool of a type other than a bucket, such as a stirrer, a breaker, a grapple, or a lifting magnet.

The slewing hydraulic motor 2A, the left traveling hydraulic motor 2ML, the right traveling hydraulic motor 2MR, the boom cylinder 7, the arm cylinder 8, and the bucket cylinder 9 are hydraulic actuators driven by hydraulic fluid discharged from hydraulic pumps.

In the work machine 100, all or some of the driven parts, such as the lower traveling body 1, the upper slewing body 3, the boom 4, the arm 5, and the bucket 6 may be electrically driven. That is, the work machine 100 may be a hybrid work machine, an electric work machine, or the like in which all or some of the driven parts are driven by electric actuators.

Further, the information transmission device G1, an external sound collection device M1, an imaging device S6, and an external sound output device SP1 are attached to the work machine 100.

The imaging device S6 is provided on the upper slewing body 3 or the cabin 10, images the surroundings of the work machine 100, and acquires image information representing the surroundings of the work machine 100. In the illustrated example, the imaging device S6 includes a front camera S6F, a left camera S6L, a right camera S6R, and a rear camera S6B.

The front camera S6F is a camera that images the front side of the work machine 100, and is attached to the outside of the cabin 10, such as the roof of the cabin 10 or the side surface of the boom 4. Note that the front camera S6F may be attached to the inside of the cabin 10, such as the ceiling of the cabin 10, for example. The left camera S6L is a camera that images the left side of the work machine 100, the right camera S6R is a camera that images the right side of the work machine 100, and the rear camera S6B is a camera that images the rear side of the work machine 100. More specifically, each of the front camera S6F, the left camera S6L, the right camera S6R, and the rear camera S6B is a monocular wide-angle camera including an image sensor such as a CCD or a CMOS, and outputs a captured image to the display device D1. Information of the image captured by the imaging device S6 is taken into the controller 30.

In the illustrated example, the front camera S6F is attached to the roof of the cabin 10, the left camera S6L is attached to the left end of the upper surface of the upper slewing body 3, the right camera S6R is attached to the right end of the upper surface of the upper slewing body 3, and the rear camera S6B is attached to the rear end of the upper surface of the upper slewing body 3.

The imaging device S6 may constitute an object detection device that detects an object around the work machine 100. The object is, for example, a person, an animal, a vehicle, a construction machine, a building, a hole, or the like. The object detection device may be configured to be able to detect a person and an object other than a person in a distinguishable manner. That is, the object detection device may be configured to function as a human detection device. The object detection device may be configured by a device other than a camera. For example, the object detection device may be a LiDAR. The LiDAR is, for example, a device capable of measuring a distance between a point group of one million or more points within a monitoring range and the LiDAR (laser source). The object detection device may be another device capable of measuring the distance to the object, such as a stereo camera, a range image camera, or a millimeter wave radar. When a millimeter wave radar or the like is used as the object detection device, the object detection device may derive the distance and direction of the object by transmitting a large number of signals (laser light or the like) toward the object and receiving the reflected signals. Alternatively, the object detection device may be a combination of two or more types of devices. For example, the object detection device may be a combination of an imaging device and a LiDAR, a combination of an imaging device and a millimeter wave radar, or a combination of an imaging device and a stereo camera.

The external sound collection device M1 is a device that collects external sound and is also called a microphone. In the illustrated example, the external sound collection device M1 is provided in the upper slewing body 3 or the cabin 10, converts sound (air vibration) generated around the work machine 100 into mechanical vibration, and converts the mechanical vibration into an electric signal. More specifically, the external sound collection device M1 is configured to be able to pick up voices uttered by the worker around the work machine 100, and includes a front microphone M1F, a left microphone M1L, a right microphone M1R, and a rear microphone M1B.

The front microphone M1F is a microphone that collects sound generated in front of the work machine 100, and is attached to the outside of the cabin 10, such as the roof of the cabin 10 or the side surface of the boom 4. The front microphone M1F may be attached to the inside of the cabin 10, for example, the ceiling of the cabin 10. The left microphone M1L is a microphone that collects sound generated on the left side of the work machine 100, the right microphone M1R is a microphone that collects sound generated on the right side of the work machine 100, and the rear microphone M1B is a microphone that collects sound generated on the rear side of the work machine 100. Then, the electric signals generated by the front microphone M1F, the left microphone M1L, the right microphone M1R, and the rear microphone M1B are taken into the controller 30.

In the illustrated example, the front microphone M1F is attached to the roof of the cabin 10, the left microphone M1L is attached to the left end of the upper surface of the upper slewing body 3, the right microphone M1R is attached to the right end of the upper surface of the upper slewing body 3, and the rear microphone M1B is attached to the rear end of the upper surface of the upper slewing body 3. In this way, the four external sound collection devices M1 (the front microphone M1F, the left microphone M1L, the right microphone M1R, and the rear microphone M1B) are provided at different positions of the upper slewing body 3. Therefore, the controller 30 can detect the direction in which the sound generation source is located based on the difference in the sound collected by each of the four external sound collection devices M1 (e.g., the difference in the volume). In addition, when an array microphone is used as the external sound collection device M1, for example, a direction in which a sound generation source is present can be detected based on a phase shift or a difference in volume.

In the illustrated example, the four external sound collection devices M1 and the four imaging devices S6 are arranged so as to correspond to each other. More specifically, the front microphone M1F is arranged adjacent to the front camera S6F, the left microphone M1L is arranged adjacent to the left camera S6L, the right microphone M1R is arranged adjacent to the right camera S6R, and the rear microphone M1B is arranged adjacent to the rear camera S6B.

The external sound output device SP1 is a device that outputs sound toward the surroundings of the work machine 100. In the illustrated example, the external sound output device SP1 is a non-directional speaker, and is configured to be able to uniformly output sound in all directions. However, the external sound output device SP1 may be a directional speaker that outputs sound in a specific direction such as forward.

An information transmission device G1 is a device for notifying those on the outside of the work machine 100 of the state of the work machine 100. In the illustrated example, the information transmission device G1 is provided in the upper slewing body 3 or the cabin 10, and is configured to be able to transmit the state of the work machine 100 to the worker around the work machine 100. In particular, the information transmission device G1 is a light emitting device and includes a front light bar G1F, a left light bar G1L, a right light bar G1R, and a rear light bar G1B.

The front light bar G1F is a light emitting device that can visually convey information to the operator or the like in front of the work machine 100, and is attached to the outside of the cabin 10, such as the roof of the cabin 10 or the side surface of the boom 4. Note that the front light bar G1F may be attached to the inside of the cabin 10, such as the ceiling of the cabin 10, for example. The left light bar G1L is a light emitting device that can visually convey information to a worker or the like on the left side of the work machine 100, the right light bar G1R is a light emitting device that can visually convey information to a worker or the like on the right side of the work machine 100, and the rear light bar G1B is a light emitting device that can visually convey information to a worker or the like on the rear side of the work machine 100. Each of the front light bar G1F, the left light bar G1L, the right light bar G1R, and the rear light bar G1B emits light in response to an electric signal from the controller 30. In the illustrated example, the light emitting device is an LED light, but may be another light emitting device such as a halogen lamp. The light emitting device is a multicolor light emitting type, but may be a monochromatic light emitting type.

In the illustrated example, the front light bar G1F is attached to the roof of the cabin 10, the left light bar G1L is attached to the left end of the upper surface of the upper slewing body 3, the right light bar G1R is attached to the right end of the upper surface of the upper slewing body 3, and the rear light bar G1B is attached to the rear end of the upper surface of the upper slewing body 3. In this way, the four information transmission devices G1 (the front light bar G1F, the left light bar G1L, the right light bar G1R, and the rear light bar G1B) are provided at different positions of the upper slewing body 3. Therefore, the controller 30 can inform the workers or the like in the front, left, right, and rear of the work machine 100 of the state of the work machine 100 by activating the four information transmission devices G1 separately.

In the illustrated example, the four information transmission devices G1 and the four external sound collection devices M1 are arranged so as to correspond to each other. In particular, the front light bar G1F is arranged adjacent to the front microphone M1F, the left light bar G1L is arranged adjacent to the left microphone M1L, the right light bar G1R is arranged adjacent to the right microphone M1R, and the rear light bar G1B is arranged adjacent to the rear microphone M1B.

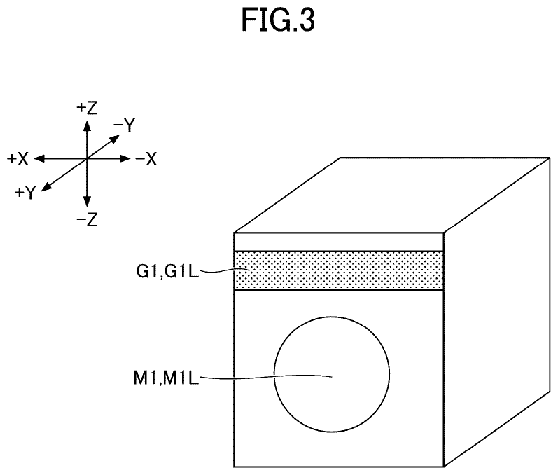

FIG. 3 is a view illustrating a configuration example of the external sound collection device M1 and the information transmission device G1 attached to the work machine 100. More specifically, FIG. 3 is a perspective view of the left microphone M1L and the left light bar G1L attached to a housing having a substantially rectangular parallelepiped shape. Note that the following description with reference to FIG. 3 relates to a combination of the left microphone M1L and the left light bar G1L, but is similarly applied to a combination of the front microphone M1F and the front light bar G1F, a combination of the right microphone M1R and the right light bar G1R, and a combination of the rear microphone M1B and the rear light bar G1B.

As illustrated in FIG. 3, the left microphone M1L and the left light bar G1L are disposed on the left side surface of the housing having a substantially rectangular parallelepiped shape so as to face the left side of the work machine 100. With this arrangement, the left microphone M1L can efficiently collect sound generated on the left side of the work machine 100, and the left light bar G1L can efficiently convey the state of the work machine 100 to the worker on the left side of the work machine 100. For example, the left microphone M1L can capture a voice uttered by a worker on the left side of the work machine 100, and the left light bar G1L can notify the worker that the left microphone M1L has captured the voice of the worker by emitting light in a predetermined color. In this case, the worker on the left side of the work machine 100 who speaks to the left microphone M1L can confirm that his/her voice has reached the left microphone M1L (i.e., the operator of the work machine 100) by viewing the left light bar G1L that emits light in a predetermined color.

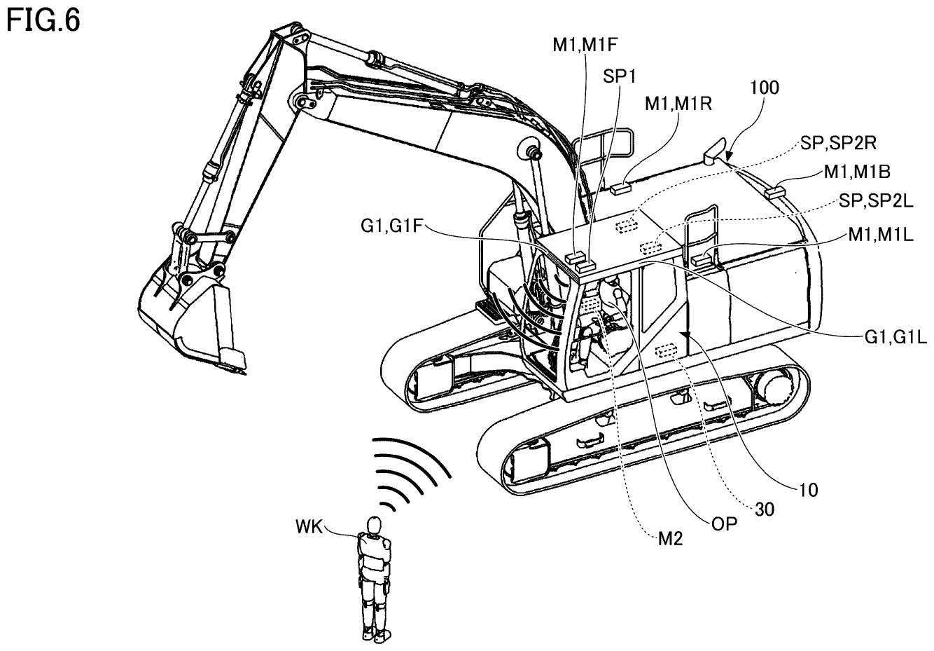

The information transmission device G1 may be provided on an upper portion of each of the four side surfaces of the cabin 10 (see FIG. 6). For example, the information transmission device G1 may be configured such that the front light bar G1F is attached to the upper portion of the front surface of the cabin 10, the left light bar G1L is attached to the upper portion of the left surface of the cabin 10, the right light bar G1R is attached to the upper portion of the right surface of the cabin 10, and the rear light bar G1B is attached to the upper portion of the rear surface of the cabin 10. The information transmission device G1 may be a single rotating light, such as a Nico Torch (Registered Trademark) attached to the upper surface of the cabin 10, or may be a display such as a liquid-crystal display or an organic EL display.

The controller 30 is an example of a control device, and is configured by a computer including a CPU, a volatile storage device, a nonvolatile storage device, various input/output interfaces, and the like, for example. The controller 30 reads the program from the nonvolatile storage device, loads a program into the volatile storage device, and causes the CPU to execute the program, thereby implementing various functions. In the illustrated example, the controller 30 is configured to be able to control the work machine 100 by implementing various functions. The various functions include, for example, a machine guidance function for guiding the manual operation of the work machine 100 by the operator. The various functions may include a contact avoidance function of automatically or autonomously activating or stopping the work machine 100 in order to avoid contact between the work machine 100 and an object present in the monitoring range around the work machine 100.

A boom angle sensor S1 detects a boom angle which is a rotation angle of the boom 4 with respect to the upper slewing body 3. An arm angle sensor S2 detects an arm angle which is a rotation angle of the arm 5 with respect to the boom 4. A bucket angle sensor S3 detects a bucket angle that is a rotation angle of the bucket 6 with respect to the arm 5.

The boom angle sensor S1, the arm angle sensor S2, and the bucket angle sensor S3 may be, for example, rotary encoders, accelerometers, six axis sensors, or IMU (Inertial Measurement Unit), or may be potentiometers using variable resistors, or cylinder stroke sensors that detect the stroke amounts of hydraulic cylinders.

A detection signal corresponding to the boom angle by the boom angle sensor S1, a detection signal corresponding to the arm angle by the arm angle sensor S2, and a detection signal corresponding to the bucket angle by the bucket angle sensor S3 are taken into the controller 30.

A body inclination sensor S4 detects an inclination state of the body (the lower traveling body 1 or the upper slewing body 3) with respect to a horizontal plane.

The body inclination sensor S4 is attached to, for example, the upper slewing body 3, and detects inclination angles of the work machine 100 (i.e., the upper slewing body 3) around two axes in the front-rear direction and the right-left direction. The body inclination sensor S4 may be, for example, an accelerometer, a six axis sensor, or an IMU. A detection signal corresponding to the inclination angle by the body inclination sensor S4 is taken into the controller 30.

A slewing sensor S5 outputs information related to the slewing of the upper slewing body 3. The slewing sensor S5 detects, for example, a slewing angular velocity of the upper slewing body 3 with respect to the lower traveling body 1. The slewing sensor S5 may detect a slewing angle. The slewing sensor S5 may be, for example, a gyro sensor, a resolver, or a rotary encoder. A detection signal corresponding to the slewing angle or slewing angular velocity of the upper slewing body 3 by the slewing sensor S5 is taken into the controller 30.

The positioning device PS measures the position of the upper slewing body 3. The positioning device PS is, for example, a global navigation satellite system (GNSS) compass, and detects the position and orientation of the upper slewing body 3. A detection signal corresponding to the position and orientation of the upper slewing body 3 is taken into the controller 30. The function of detecting the orientation of the upper slewing body 3 may be implemented by an orientation sensor attached to the upper slewing body 3.

The cabin 10 is a partitioned space where an operator gets into and is provided on the front left side of the upper slewing body 3. However, in a case where the work machine 100 is remotely controlled, or in a case where the work machine 100 is activated by fully automatic driving, the cabin 10 may be omitted.

A communication device T1 communicates with external devices via communication networks including mobile communication networks, satellite communication networks, Internet networks, and the like. The communication device T1 is, for example, a mobile communication module corresponding to a mobile communication standard such as Long Term Evolution (LTE), 4G (4th Generation), or 5G (5th Generation), a communication module corresponding to a short-range wireless communication standard such as Wi-Fi (trademark) or Bluetooth (trademark), or a satellite communications module for connecting to a satellite communications network.

The work machine 100 activates the actuator in response to an operation of an operator who has entered the cabin 10, and drives the driven parts such as the lower traveling body 1, the upper slewing body 3, the boom 4, the arm 5, and the bucket 6.

Alternatively, the work machine 100 may be configured to be remotely controlled from the outside of the work machine 100. When the work machine 100 is remotely controlled, the inside of the cabin 10 may be unmanned.

The work machine 100 may automatically activate the actuator independent of the content of the operation by the operator. Thus, the work machine 100 implements a function of automatically activating at least some of the driven parts such as the lower traveling body 1, the upper slewing body 3, the boom 4, the arm 5, and the bucket 6, that is, a so-called “machine control function”.

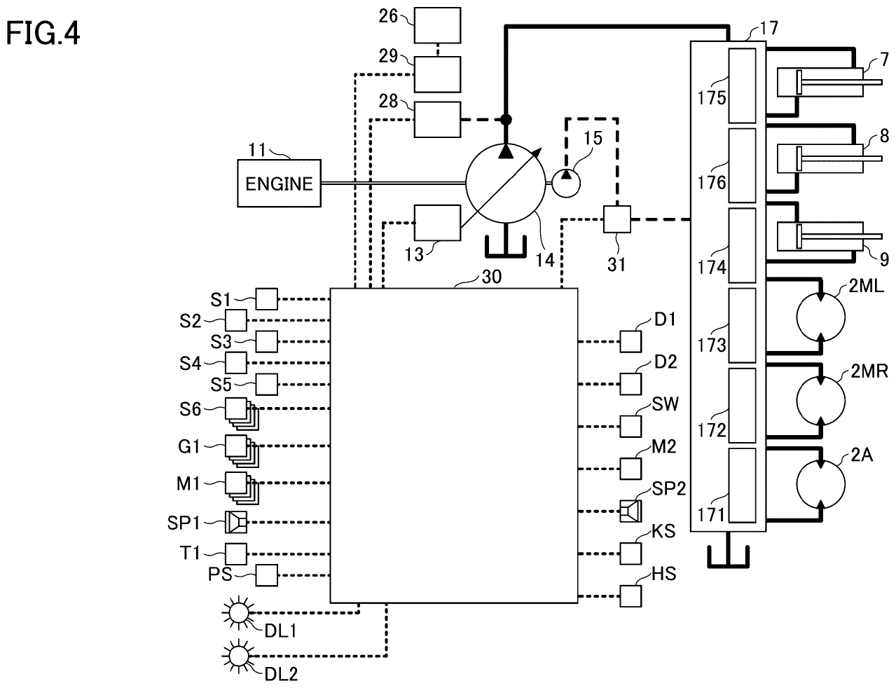

FIG. 4 is a diagram schematically illustrating a configuration example of the work machine 100. In FIG. 4, the mechanical power transmission system, the hydraulic fluid line, the pilot line, and the electric control system are indicated by a double line, a thick solid line, a thick broken line, and a dotted line, respectively.

The drive system of the work machine 100 includes an engine 11, the regulator 13, a main pump 14, and the control valve unit 17. The hydraulic drive system of the work machine 100 includes hydraulic actuators such as a slewing hydraulic motor 2A, the left traveling hydraulic motor 2ML, the right traveling hydraulic motor 2MR, the boom cylinder 7, an arm cylinder 8, and a bucket cylinder 9.

The engine 11 is an example of a power source of the work machine 100, and is mounted, for example, on a rear portion of the upper slewing body 3. The power source of the work machine 100 may be a combination of a power source such as a battery or a fuel cell and an electric motor. Specifically, the engine 11 rotates at a constant target rotation speed set in advance under direct or indirect control of the controller 30, and drives the main pump 14 and a pilot pump 15. The engine 11 is, for example, a diesel engine using diesel as fuel. The engine 11 may be a gasoline engine, a hydrogen engine, or the like.

The regulator 13 controls the discharge amount of the main pump 14. For example, the regulator 13 controls the discharge amount of the main pump 14 by adjusting the angle (tilting angle) of the swash plate of the main pump 14 in response to a control command from the controller 30.

The main pump 14 is mounted, for example, on the rear portion of the upper slewing body 3 similarly to the engine 11, and supplies the hydraulic fluid to the control valve unit 17 through the hydraulic fluid line. In the illustrated example, the main pump 14 is a variable displacement hydraulic pump.

The control valve unit 17 is one of the hydraulic control devices that control the hydraulic system in the work machine 100. In the illustrated example, the control valve unit 17 includes control valves 171 to 176. The control valve unit 17 is configured to be able to selectively supply the hydraulic fluid discharged by the main pump 14 to one or a plurality of hydraulic actuators through the control valves 171 to 176. The control valves 171 to 176 control the flow rate of the hydraulic fluid flowing from the main pump 14 to the hydraulic actuator and the flow rate of the hydraulic fluid flowing from the hydraulic actuator to the hydraulic fluid tank. The hydraulic actuators include the boom cylinder 7, an arm cylinder 8, a bucket cylinder 9, the left traveling hydraulic motor 2ML, the right traveling hydraulic motor 2MR, and the slewing hydraulic motor 2A. More specifically, the control valve 171 corresponds to the left traveling hydraulic motor 2ML, the control valve 172 corresponds to the right traveling hydraulic motor 2MR, and the control valve 173 corresponds to the slewing hydraulic motor 2A. The control valve 174 corresponds to the bucket cylinder 9, the control valve 175 corresponds to the boom cylinder 7, and the control valve 176 corresponds to the arm cylinder 8.

The pilot pump 15 is an example of a pilot pressure generating device and is configured to be able to supply the hydraulic fluid to the hydraulic control device via a pilot line. In the illustrated example, the pilot pump 15 is a fixed displacement hydraulic pump. However, the pilot pressure generating device may be implemented by the main pump 14. That is, the main pump 14 may have a function of supplying the hydraulic fluid to various hydraulic control devices via the pilot line, in addition to the function of supplying the hydraulic fluid to the control valve unit 17 via the hydraulic fluid line. In this case, the pilot pump 15 may be omitted.

The discharge pressure sensor 28 is configured to detect the discharge pressure of the main pump 14. In the illustrated example, the discharge pressure sensor 28 outputs the detected value to the controller 30.

The operation device 26 is a device used by an operator to operate the actuator. The operation device 26 includes, for example, an operation lever and an operation pedal. The actuator may be a hydraulic actuator or an electric actuator.

The operation sensor 29 is configured to detect the content of an operation performed by the operator using the operation device 26. In the present embodiment, the operation sensor 29 detects the operation direction and the operation amount of the operation device 26 corresponding to each of the actuators, and outputs the detected values to the controller 30. In the illustrated example, the controller 30 can control the opening area of a valve 31 in accordance with the output of the operation sensor 29. The controller 30 supplies the hydraulic fluid discharged from the pilot pump 15 to the pilot port of the corresponding control valve in the control valve unit 17. The pressure of the hydraulic fluid supplied to each of the pilot ports (pilot pressure) is, in principle, a pressure corresponding to the operation direction and the operation amount of the operation device 26 corresponding to each of the hydraulic actuators. In this way, the operation device 26 is configured to be able to supply the hydraulic fluid discharged by the pilot pump 15 to the pilot port of the corresponding control valve in the control valve unit 17.

The valve 31 functioning as a control valve for machine control is disposed in a conduit connecting the pilot pump 15 and a pilot port of a control valve in the control valve unit 17, and is configured to be able to change a flow passage area of the conduit. In the illustrated example, the valve 31 is an electromagnetic valve that is activated in response to a control command output from the controller 30. Therefore, the controller 30 can adjust the pilot pressure acting on the pilot port of the control valve by the valve 31, independently of the operation of the operation device 26 by the operator.

With this configuration, even when an operation is not performed on a specific operation device 26, the controller 30 can activate the hydraulic actuator corresponding to the specific operation device 26.

As illustrated in FIG. 4, the control system of the work machine 100 includes the controller 30, the display device D1, the input device D2, a horn button HS, the speech button KS, the external sound collection device M1, an internal sound collection device M2, the external sound output device SP1, an internal sound output device SP2, the external volume dial DL1, the internal volume dial DL2, the switch SW, the communication device T1, and the like.

The controller 30 is configured to be able to output a control command to the regulator 13 as necessary and change the discharge amount of the main pump 14. Further, the controller 30 may be configured to perform control related to a machine guidance function for guiding (leading) manual operation of the work machine 100 by the operator through the operation device 26, for example. Further, the controller 30 may be configured to perform control related to a machine control function of automatically supporting manual operation of the work machine 100 by the operator through the operation device 26, for example. Note that some of the functions of the controller 30 may be implemented by another controller (control device). That is, the functions of the controller 30 may be implemented in a distributed manner by a plurality of controllers. For example, the machine guidance function and the machine control function may be implemented by a dedicated controller (control device).

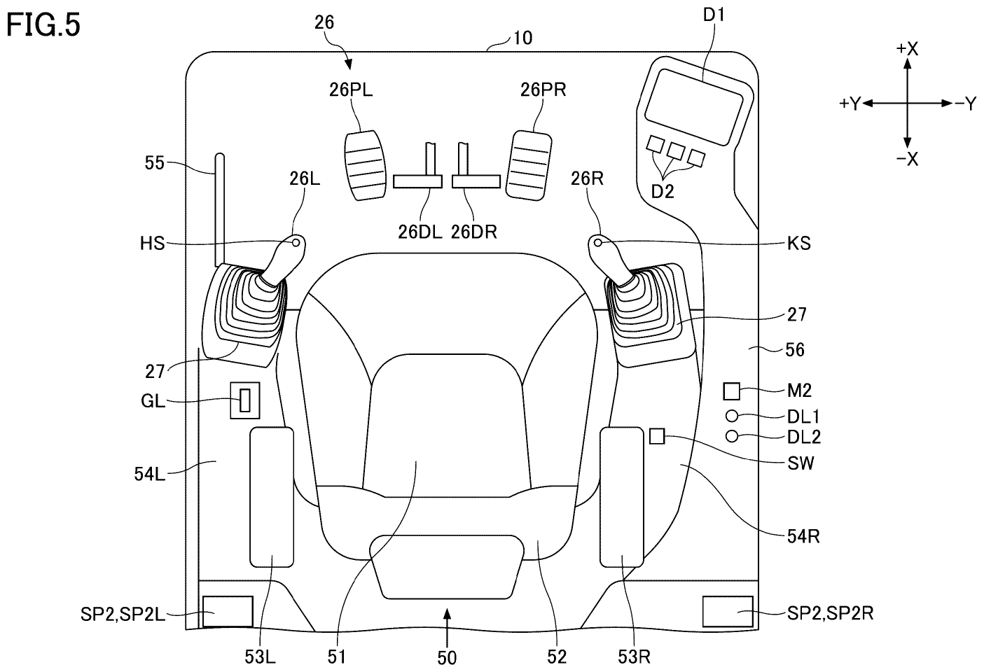

Here, the inside of the cabin 10 will be described with reference to FIG. 5. FIG. 5 is a top view illustrating an inside of the cabin 10. The work machine 100 includes an operator's seat 50, an operation device 26, a display device D1, and the like, which are disposed inside the cabin 10. A door for getting in and out is provided on the left side of the operator's seat 50. The operator can enter the inside of the cabin 10 by opening the entrance door.

The operator's seat 50 is disposed at the center of the cabin 10 in a top view. The operator's seat 50 includes a seat 51 on which an operator sits and a backrest 52. The operator's seat 50 is a reclining seat, and the inclination angle of the backrest 52 is adjustable. A left arm rest 53L is disposed on the left side of the operator's seat 50, and a right arm rest 53R is disposed on the right side of the operator's seat 50. The left arm rest 53L and the right arm rest 53R are rotatably supported by the backrest 52.

A left console 54L is disposed on the left side of the operator's seat 50, and a right console 54R is disposed on the right side of the operator's seat 50. The left console 54L and the right console 54R extend along the front-rear direction. The operator's seat 50 is slidable in the front-rear direction. The operator's seat 50 may be configured to be slidable in the front-rear direction together with the left console 54L and the right console 54R.

The left arm rest 53L is disposed on the left console 54L. The right arm rest 53R is disposed on the right console 54R. The left arm rest 53L is disposed so as to cover a part of the left console 54L in a top view. The right arm rest 53R is disposed so as to cover a part of the right console 54R in a top view.

The operation device 26 includes a left operation lever 26L, a right operation lever 26R, a left traveling pedal 26PL, a right traveling pedal 26PR, a left traveling lever 26DL, and a right traveling lever 26DR. The left operation lever 26L is provided at a front portion of the left console 54L. Similarly, the right operation lever 26R is provided at a front portion of the right console 54R. The operator seated in the operator's seat 50 can operate the left operation lever 26L while gripping the left operation lever 26L with the left hand, and can operate the right operation lever 26R while gripping the right operation lever 26R with the right hand. The operator seated in the operator's seat 50 can operate the left operation lever 26L with the left hand to drive the arm cylinder 8 and the slewing hydraulic motor 2A. The operator seated in the operator's seat 50 can operate the right operation lever 26R with the right hand to drive the boom cylinder 7 and the bucket cylinder 9. The base of each of the left operation lever 26L and the right operation lever 26R is covered with a lever boot 27.

The left traveling pedal 26PL and the right traveling pedal 26PR are disposed on the floor surface in front of the operator's seat 50. The operator seated in the operator's seat 50 can operate the left traveling pedal 26PL with his/her left foot to drive the left traveling hydraulic motor 2ML. The operator seated in the operator's seat 50 can operate the right traveling pedal 26PR with the right foot to drive the right traveling hydraulic motor 2MR.

The left traveling lever 26DL and the right traveling lever 26DR are disposed between the left traveling pedal 26PL and the right traveling pedal 26PR in a top view. The left traveling lever 26DL and the right traveling lever 26DR extend upward from the floor surface in front of the operator's seat 50. The operator seated in the operator's seat 50 can drive the left traveling hydraulic motor 2ML by operating the left traveling lever 26DL while gripping the left traveling lever 26DL with the left hand, similarly to the operation via the left traveling pedal 26PL. Further, the operator seated in the operator's seat 50 can drive the right traveling hydraulic motor 2MR by operating the right traveling lever 26DR while gripping the right traveling lever 26DR with the right hand, similarly to the operation via the right traveling pedal 26PR. The left traveling lever 26DL and the right traveling lever 26DR are arranged so that the operator can operate the left traveling lever 26DL and the right traveling lever 26DR simultaneously with one hand.

The display device D1 is provided at a position in the cabin 10 where the display device D1 is easily visible to the seated operator, and displays various information images under the control of the controller 30. In the illustrated example, the display device D1 is disposed on the right front side of the operator's seat 50 and is connected to the controller 30 via a dedicated line. The display device D1 displays various kinds of image information. The display device D1 includes a display screen that displays information such as the work conditions or the activation state of the work machine 100. The operator seated in the operator's seat 50 can perform work with the work machine 100 while checking various information displayed on the display device D1. The display device D1 may be provided with an input device D2.

The input device D2 is provided within reach of the operator seated in the operator's seat 50, receives various operation inputs from the operator, and outputs signals corresponding to the operation inputs to the controller 30. The input device D2 includes a touch panel mounted on a display of the display device D1 that displays various information images, a knob switch provided at a tip of one or more lever portions of a plurality of operation levers included in the operation device 26, or a button switch, a lever, a toggle switch, a rotary dial, or the like installed around the display device D1. A signal corresponding to the content of the operation on the input device D2 is taken into the controller 30.

A gate bar 55 is attached to the front surface of the front end portion of the left console 54L. The gate bar 55 activates in conjunction with an operation state of a gate lock lever GL provided on the left console 54L. The gate bar 55 is attached to a frame inside the left console 54L so as to be able to rise and fall about a shaft extending in the left-right direction at the upper end portion.

The gate lock lever GL is a mechanical input operation unit for switching between a state in which the work machine 100 can be operated by the operation device 26 (operable state) and a state in which the work machine 100 cannot be operated by the operation device 26 (inoperable state). In the illustrated example, the gate lock lever GL is configured such that the operator can switch between a first operation position for implementing the inoperable state and a second operation position for implementing the operable state. The controller 30 switches between an operable state and an inoperable state in accordance with the operation state of the gate lock lever GL. In the illustrated example, the controller 30 electrically switches the pilot line between a communication state and a non-communication state in accordance with the operation state of the gate lock lever GL, thereby switching the work machine 100 between the operable state and the inoperable state.

When the gate lock lever GL is at the second operation position, the gate bar 55 is in a state of being raised forward so as to prevent the operator from passing through the entrance door (passing prohibited state), as illustrated in FIG. 5. When the gate lock lever GL is at the first operation position, the gate bar 55 is housed in the left console 54L so as not to hinder the operator from passing through the entrance door (passing permission state).

With this configuration, the operator cannot operate the work machine 100 unless the gate lock lever GL is located at the second operation position to set the gate bar 55 in the passing prohibited state. Therefore, this configuration can prevent the work machine 100 from moving unintentionally even when the operator touches the operation device 26 inadvertently when getting in and out. Therefore, this configuration can improve the safety of the work machine 100.

The work machine 100 may be configured to be able to receive a predetermined operation for starting the engine 11 only when the gate lock lever GL is at the second operation position and the gate bar 55 is in the passing prohibited state. That is, the work machine 100 may be configured such that the engine 11 cannot be started when the gate lock lever GL is at the first operation position and the gate bar 55 is in the passing permission state.

A switch SW is provided on the right console 54R. A window side console 56 is installed on the right side of the right console 54R. The window side console 56 extends over the entire length of the cabin 10 in the front-rear direction, and is provided so as to be parallel to the right console 54R. The display device D1 is installed in front of the window side console 56. The window side console 56 is provided with an external volume dial DL1, an internal volume dial DL2, an internal sound collection device M2, a radio tuner, and the like. The radio tuner or the like may be installed on the left console 54L or the right console 54R.

An internal sound collection device M2 is a device that collects sound generated in the cabin 10. In the illustrated example, the internal sound collection device M2 is an indoor microphone, and is configured to be able to pick up voices uttered by the operator in the cabin 10.

The horn button HS is a button operated by the operator of the work machine 100 when sounding a horn sound. In the illustrated example, the horn button HS is a knob switch provided at the distal end of the left operation lever 26L.

The speech button KS is a button operated by the operator of the work machine 100 when the operator of the work machine 100 speaks to a worker around the work machine 100. In the illustrated example, the speech button KS is a knob switch provided at the tip of the right operation lever 26R.

The internal sound output device SP2 is a device that outputs sound toward the operator in the cabin 10, and is provided in the cabin 10. The internal sound output device SP2 converts an electric signal input from the controller 30 into a physical sound (vibration of air) and outputs the physical sound. The internal sound output device SP2 may be provided at any position, and may be provided, for example, in the vicinity of the display device D1, in the vicinity of the input device D2, or in the vicinity of the entrance door of the cabin 10. In the illustrated example, the internal sound output device SP2 includes a left indoor speaker SP2L attached to an upper left corner of the rear wall of the cabin 10 and a right indoor speaker SP2R attached to an upper right corner of the rear wall of the cabin 10. The internal sound output device SP2 may be a headphone or an earphone worn by the operator. In this case, the headphone or earphone is connected to the controller 30 via, for example, Bluetooth (registered trademark) so as to be able to communicate with the controller 30.

The external volume dial DL1 is configured to adjust the volume of the sound output by the external sound output device SP1. The volume of the sound output by each external sound output device SP1 may be additionally adjusted by using a device other than the external volume dial DL1, such as a touch panel attached to the display device D1.

The external volume dial DL1 may be configured to be infinitely rotatable in each of the clockwise and counterclockwise directions. This is to accommodate a case where the volume adjustment using the external volume dial DL1 and the volume adjustment using a device other than the external volume dial DL1 are used together.

The internal volume dial DL2 is configured to adjust the volume of the sound output by the internal sound output device SP2. The volume of the sound output from each internal sound output device SP2 may be additionally adjusted by using a device other than the internal volume dial DL2, such as a touch panel attached to the display device D1.

The internal volume dial DL2 may be configured to be infinitely rotatable in each of the clockwise and counterclockwise directions. This is to accommodate a case where the volume adjustment using the internal volume dial DL2 and the volume adjustment using a device other than the internal volume dial DL2 are used together.

The switch SW is an example of an operation tool for switching the activation state of the conversation function. In the illustrated example, the switch SW is provided on the upper surface of the right console 54R. However, the switch SW may be one of the input devices D2, may be implemented by a touch panel provided on the display device D1, or may be a knob switch.

The conversation function is a function for implementing a conversation between the operator OP of the work machine 100 and the worker WK around the work machine 100 as illustrated in FIG. 6. FIG. 6 is a perspective view illustrating the work machine 100 on which the operator OP is riding and the worker WK in front of the work machine 100 on the left. FIG. 6 shows a state in which the voice of the operator OP is being collected by the internal sound collection device M2 and output from the external sound output device SP1, and the voice of the worker WK is collected by the external sound collection device M1 and output from the internal sound output device SP2. In the work machine 100 illustrated in FIG. 6, the information transmission device G1 is provided on the upper portion of each of the four side surfaces of the cabin 10. The front light bar G1F provided at the upper portion of the front surface of the cabin 10 emits green light, and the left light bar G1L provided at the upper portion of the left surface of the cabin 10 emits white light. In FIG. 6, a dot pattern is given to the front light bar G1F emitting green light. The worker WK who sees the front light bar G1F emitting green light can recognize that his/her voice is detected by the front microphone M1F. Note that, in FIG. 6, other devices such as the imaging device S6 are not illustrated for the sake of clarity.

The activation state of the conversation function includes an ON state (state illustrated in FIG. 6) in which a conversation between the operator OP and the worker WK is possible, and an OFF state in which a conversation between the operator OP and the worker WK is not possible. However, the activation state of the conversation function may additionally include at least one of a hearable state (related to the operator OP) in which the operator OP can hear the voice of the worker WK but the worker WK cannot hear the voice of the operator OP and an utterable state (related to the operator OP) in which the worker WK can hear the voice of the operator OP but the operator OP cannot hear the voice of the worker WK.

In detail, when the activation state of the conversation function is switched to the ON state by operating the switch SW, the external sound collection device M1, the external sound output device SP1, the internal sound collection device M2, and the internal sound output device SP2 are in an available state. When the switch SW is operated and the activation state of the conversation function is switched to the OFF state, the external sound collection device M1, the external sound output device SP1, the internal sound collection device M2, and the internal sound output device SP2 are in the unavailable state. When the switch SW is operated to switch the activation state of the conversation function to the hearable state, the external sound collection device M1 and the internal sound output device SP2 are brought into the available state. When the switch SW is operated to switch the activation state of the conversation function to the utterable state, the external sound output device SP1 and the internal sound collection device M2 are enabled. In the illustrated example, the operator OP can speak to the worker WK using the external sound output device SP1 by speaking while pressing the speech button KS when the internal sound collection device M2 is in an available state.

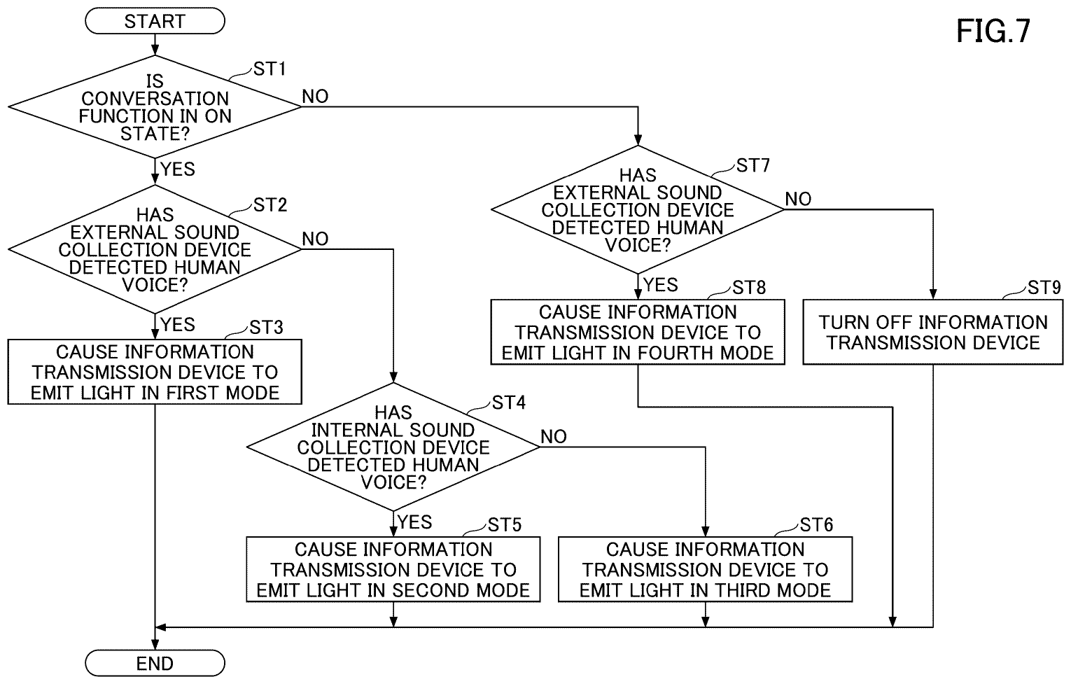

Next, referring to FIG. 7, a process (hereinafter, referred to as an “information transmission process”) in which the controller 30 controls the information transmission device G1 to transmit information to the surroundings of the work machine 100 will be described. FIG. 7 is a flowchart illustrating an example of a sequence of an information transmission process. The controller 30 repeatedly executes the information transmission process at a predetermined control cycle.

First, the controller 30 determines whether or not the conversation function is in the ON state (step ST1). In the illustrated example, the operator OP can switch the activation state of the conversation function between the ON state and the OFF state by operating the switch SW.

When the controller 30 determines that the conversation function is in the ON state (YES in step ST1), the controller 30 determines whether or not the external sound collection device M1 has detected a human voice (step ST2). In the illustrated example, the controller 30 analyzes frequencies of electric signals corresponding to sounds collected by the external sound collection device M1, and determines whether or not a voice of a person (the worker WK) is included in the sounds collected by the external sound collection device M1, that is, whether or not the external sound collection device M1 has picked up a voice of a person. The controller 30 may determine whether or not a human voice is included based on waveform patterns of electric signals corresponding to the sounds collected by the external sound collection device M1. Further, the functions related to these sounds may be implemented by a device (e.g., an independent sound controller) different from the controller 30.

When the controller 30 determines that the external sound collection device M1 has detected a human voice (YES in step ST2), the controller 30 causes the information transmission device G1 to emit light in the first mode (step ST3). In the illustrated example, the controller 30 outputs a control command to each of the four information transmission devices G1 (the rear light bar G1B, the front light bar G1F, the left light bar G1L, and the right light bar G1R), and causes each of the four information transmission devices G1 to emit green light.

The worker WK who sees the information transmission device G1 emitting green light due to the utterance of the worker WK can recognize that the voice of the worker WK has reached the operator OP of the work machine 100. This is because the worker WK can assume that his/her voice collected by the external sound collection device M1 should have been output from the internal sound output device SP2.

When the controller 30 determines that the external sound collection device M1 does not detect a human voice (NO in step ST2), the controller 30 determines whether the internal sound collection device M2 has detected a human voice (step ST4). In the illustrated example, the controller 30 analyzes frequencies of electric signals corresponding to sounds collected by the internal sound collection device M2, and determines whether or not a voice of a person (operator OP) are included in the sounds collected by the internal sound collection device M2, that is, whether or not the internal sound collection device M2 has picked up the voice of the person. The controller 30 may determine whether or not a human voice is included based on a waveform pattern of an electric signal corresponding to the sound collected by the internal sound collection device M2.

When the controller 30 determines that the internal sound collection device M2 has detected a human voice (YES in step ST4), the controller 30 causes the information transmission device G1 to emit light in the second mode (step ST5). In the illustrated example, the controller 30 outputs a control command to each of the four information transmission devices G1, and causes each of the four information transmission devices G1 to emit blue light. The worker WK who sees the information transmission device G1 emitting blue light can recognize that the operator OP of the work machine 100 is speaking toward the outside.

When the controller 30 determines that the internal sound collection device M2 does not detect a human voice (NO in step ST4), the controller 30 causes the information transmission device G1 to emit light in the third mode (step ST6). In the illustrated example, the controller 30 outputs a control command to each of the four information transmission devices G1, and causes each of the four information transmission devices G1 to emit white light. The worker WK who sees the white light emitted by the information transmission device G1 can recognize that the conversation function of the work machine 100 is in the ON state. Further, the worker WK can recognize that the operator OP of the work machine 100 is not speaking. That is, the worker WK can recognize that it is a timing suitable for the worker WK to speak.

In addition, when the information transmission device G1 emits light in white instead of green even though the worker WK is speaking, the worker WK can recognize that his/her voice is not detected by the external sound collection device M1 for a certain factor. The certain factor is, for example, the loudness of the voice of the worker WK, the length between the work machine 100 (external sound collection device M1) and the worker WK, or the loudness of surrounding noise.

When the controller 30 determines that the conversation function is not in the ON state (NO in step ST1), the controller 30 determines whether or not the external sound collection device M1 has detected a human voice (step ST7).

Then, when the controller 30 determines that the external sound collection device M1 has detected a human voice (YES in step ST7), the controller 30 causes the information transmission device G1 to emit light in the fourth mode (step ST8). In the illustrated example, the controller 30 outputs a control command to each of the four information transmission devices G1, and causes each of the four information transmission devices G1 to emit red light. The worker WK who sees the information transmission device G1 emitting red light due to the utterance of the worker WK can recognize that the external sound collection device M1 is in an available state but the voice of the worker WK does not reach the operator OP of the work machine 100. This is because the internal sound output device SP2 is not in an available state, and thus the worker WK can assume that his/her voice collected by the external sound collection device M1 is not output from the internal sound output device SP2.

When the controller 30 determines that the external sound collection device M1 does not detect a human voice (NO in step ST7), the controller 30 turns off the information transmission device G1 (step ST9). In the illustrated example, the controller 30 outputs a control command to each of the four information transmission devices G1 to stop the light emission of each of the four information transmission devices G1. Each of the four information transmission devices G1 stops light emission when a corresponding one of the four information transmission devices G1 emits light, and maintains the state as it is when the corresponding one of the four information transmission devices G1 does not emit light.

The worker WK who sees the information transmission device G1 not emitting light can recognize that the conversation function of the work machine 100 is not in the ON state. That is, even if the worker WK speaks to the external sound collection device M1, the worker WK can recognize that his/her voice is not transmitted to the operator OP.

In this way, the worker WK can recognize the light emission mode of the information transmission device G1 to grasp the current situation such as whether or not the voice of the worker WK is being reached the operator OP or whether or not the operator OP is speaking.

In the above-described example, the first to fourth modes are distinguished from each other by the difference in the emission color. However, the first to fourth modes may be distinguished from each other by the difference in the shade, the luminance, the blinking pattern, or the like, or a combination thereof. For example, each of the first to fourth modes may be implemented by changing the blinking pattern of a light emitter that emits light in a single color. The changing of the blinking pattern may be implemented by changing at least one of the turn-on time and the turn-off time of the light emitter.

In addition, the emission color used in each of the first to fourth modes distinguished by the difference in emission color is desirably an emission color (e.g., blue) other than the emission colors (green, yellow, and red) used in the three color lamp (revolving light) attached to the hydraulic excavator with a crane function. This is to avoid the worker WK confusing the luminescent color of the information transmission device G1 indicating the activation state of the conversation function and the luminescent color of the three color lamp indicating the load state of the hydraulic excavator with a crane function. Further, the emission color used in each of the first to fourth modes is desirably an emission color (e.g., white) other than the emission color (e.g., blue) of the light emitter attached to the remote-control type work machine. This is to avoid the worker WK confusing the luminescent color of the information transmission device G1 indicating the activation state of the conversation function and the luminescent color of the light emitter indicating the remote-control type work machine.

In the above example, the controller 30 is configured to cause all of the four information transmission devices G1 to emit light, but may be configured to cause some of the four information transmission devices G1 to emit light. For example, the controller 30 may be configured to cause one of the four light sources that is located closest to the worker WK who utters a voice to emit light and not to cause the remaining three light sources to emit light. In this case, the controller 30 may determine which of the four information transmission devices G1 is located closest to the worker WK based on a difference in detection timing of the voice of the worker WK, a difference in volume of the detected voice, or the like. Alternatively, the controller 30 may be configured to cause two of the light sources located relatively close to the worker WK who utters voices to emit light and not to cause the remaining two light sources located relatively far from the worker WK to emit light.

In the above-described example, the information transmission device G1 is configured to include the light emitter (light bar) attached to the work machine 100, but the light emitter (light bar) may be installed in the work site instead of being attached to the work machine 100. In this case, the information transmission device G1 may be a transmission device that transmits a signal to a light emitter (light bar) installed in the work site. In this configuration, the worker WK can recognize the current situation, for example, whether or not his/her voice has reached the operator OP or whether or not the operator OP is speaking, by recognizing the light emission mode of the light emitter (light bar) installed in the work site.

Alternatively, when the information transmission device G1 is a transmission device, the light emitter (light bar) may be replaced with a mobile device such as a smartphone carried by the worker WK. In this case, the mobile device that has received a signal from the information transmission device G1 serving as the transmission device may cause a light emitting device such as a display screen to emit light in a predetermined mode, may cause the mobile device to vibrate in a predetermined mode, or may cause a sound output device such as a speaker or a buzzer attached to the mobile device to output sound in a predetermined mode. In this configuration, the worker WK can recognize the current situation such as whether or not his/her voice has reached the operator OP or whether or not the operator OP is speaking by recognizing the light emission mode, the vibration mode, or the sound output mode of the light emitting device of the mobile terminal carried by the worker WK.

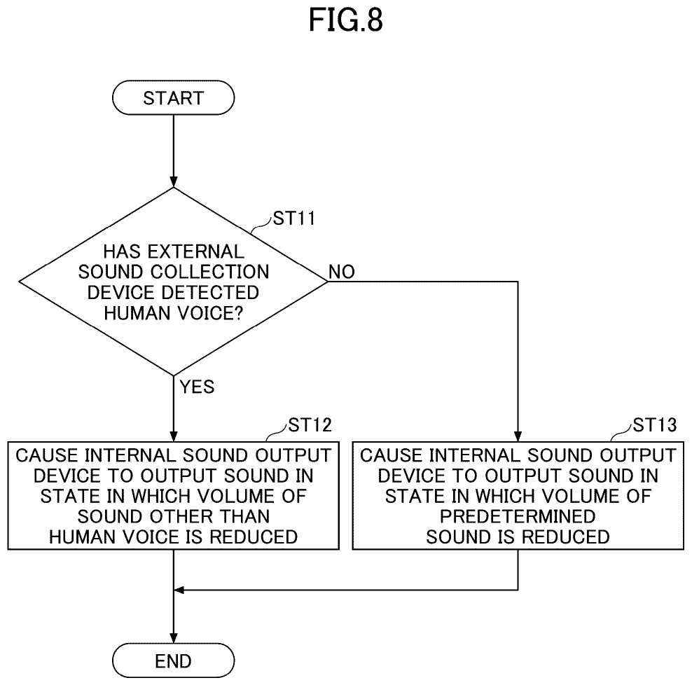

Next, with reference to FIG. 8, a process (hereinafter, referred to as a “sound transmission process”) in which the controller 30 transmits the sound around the work machine 100 to the operator OP will be described. FIG. 8 is a flowchart illustrating an example of a proceed of the sound transmission process. The controller 30 repeatedly executes the sound transmission process at a predetermined control cycle.

First, the controller 30 determines whether the external sound collection device M1 has detected a human voice (step ST11). In the illustrated example, the controller 30 analyzes the frequencies of the electric signals corresponding to the sounds collected by the external sound collection device M1 and determines whether or not the sounds collected by the external sound collection device M1 include a voice of a person (worker WK), that is, whether or not the external sound collection device M1 has picked up a voice of a person, as in the information transmission process. The controller 30 may determine whether or not a human voice is included based on a waveform pattern of an electric signal corresponding to a sound collected by the external sound collection device M1.

When the controller 30 determines that the external sound collection device M1 has detected a human voice (YES in step ST11), the controller 30 causes the internal sound output device SP2 to output a sound in a state in which the volume of a sound other than a human voice is reduced (step ST12). In the illustrated example, the sound other than the human voice is, for example, a sound generated by the work machine 100, a sound generated by another work machine other than the work machine 100, or the like. The controller 30 adjusts the waveform of the electric signal corresponding to the sound collected by the external sound collection device M1 so that the volume of the sound other than the voice of the person (worker WK) among the sounds collected by the external sound collection device M1 is reduced, and outputs the sound corresponding to the adjusted electric signal from the internal sound output device SP2. The sound other than the human voice may not include a specific sound. The specific sound is, for example, a sound such as a traveling alarm, a whistle, or a warning sound. That is, the controller 30 may cause the internal sound output device SP2 to output sound so that the volume of human voice and specific sound is not reduced. This is because the sound such as the traveling alarm, the whistle, or the warning sound is considered to be a sound that should be heard by the operator OP even during the conversation.

By this process, the operator OP of the work machine 100 can easily hear the voice of the worker WK compared to a case where the volume of the sound other than the voice of the person (worker WK) is not reduced. Therefore, this configuration can prevent the occurrence of a situation in which the operator OP does not notice that the worker WK is speaking.

When the controller 30 determines that the external sound collection device M1 does not detect a human voice (NO in step ST11), the controller 30 causes the internal sound output device SP2 to output a sound in a state in which the volume of the predetermined sound is reduced (step ST13). In the illustrated example, the predetermined sound is, for example, a sound generated by the engine 11 mounted on the work machine 100. The controller 30 adjusts the waveform of the electric signal corresponding to the sound collected by the external sound collection device M1 so that the volume of a predetermined sound among the sounds collected by the external sound collection device M1 is reduced, and outputs the sound corresponding to the adjusted electric signal from the internal sound output device SP2. Specifically, the controller 30 can adjust the waveform of the electric signal so that the volume of the predetermined sound is reduced by analyzing at least one of the frequency and the waveform pattern of the electric signals corresponding to the sounds collected by the external sound collection device M1. More specifically, the controller 30 can adjust the waveform of the electric signal so that the volume of the predetermined sound is reduced by using at least one of the frequency and the waveform pattern of the predetermined sound stored in advance in the nonvolatile storage device or the like.

By this processing, the operator OP of the work machine 100 can easily hear sounds other than the predetermined sound (e.g., sounds such as a traveling alarm, a whistle, or a warning sound), compared to a case where the volume of the predetermined sound is not suppressed. Therefore, this configuration can prevent the operator OP from failing to hear sounds other than the predetermined sound.

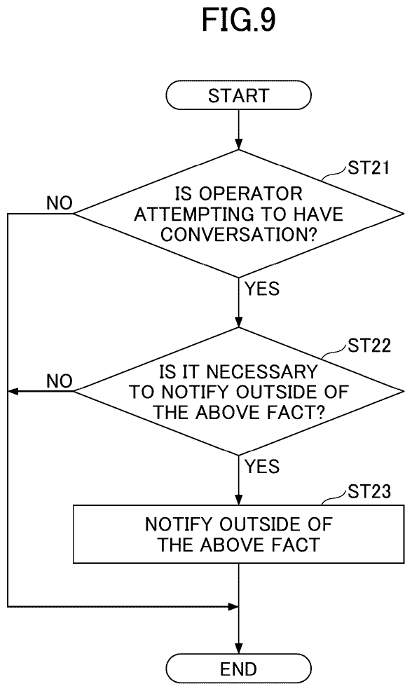

Next, a process of notifying the worker WK that the operator OP is attempting to have a conversation (hereinafter, referred to as a “conversation notification process”) will be described with reference to FIG. 9. FIG. 9 is a flowchart illustrating an example of a proceed of the conversation notification process. The controller 30 repeatedly executes the conversation notification process at a predetermined control cycle.

First, the controller 30 determines whether the operator OP is attempting to have a conversation (step ST21). In the illustrated example, when the speech button KS is pressed while the conversation function is in an ON state, the controller 30 determines that the operator OP is attempting to have a conversation. However, the controller 30 may determine that the operator OP is attempting to have a conversation when determining that the internal sound collection device M2 has detected a human voice independent of whether the speech button KS is pressed, or may determine that the operator OP is attempting to have a conversation when determining that the internal sound collection device M2 has detected a human voice in a state where the speech button KS is pressed. Alternatively, the controller 30 may determine that the operator OP is attempting to have a conversation when the internal sound collection device M2 has detected that a specific word is uttered in the cabin 10, independent of whether the speech button KS is pressed. The specific word is, for example, “conversation start” or “conversation function”.

When the controller 30 determines that the operator OP is not attempting to have a conversation (NO in step ST21), the controller 30 ends the conversation notification process of this time without giving any notification to the surroundings of the work machine 100.

When the controller 30 determines that the operator OP is attempting to have a conversation (YES in step ST21), the controller 30 determines whether or not it is necessary to notify those on the outside of the fact (that the operator OP is attempting to have a conversation) (step ST22). In the illustrated example, the controller 30 determines that it is necessary to notify those on the outside that the operator OP is attempting to have a conversation when the elapsed time from the time point when the previous notification is performed exceeds a predetermined time (e.g., one minute). In other words, when the elapsed time from the time point at which the previous notification is performed is shorter than a predetermined time (e.g., one minute), the controller 30 determines that it is not necessary to notify those on the outside that the operator OP is attempting to have a conversation.

In the illustrated example, the notification to the outside is implemented by outputting a predetermined sound from the external sound output device SP1. The predetermined sound is a sound for informing the surroundings that the operator OP is attempting to have a conversation. The predetermined sound may be, for example, a relatively high electronic sound such as “beep”, or may be a sound that does not drown out a human voice even when output simultaneously with the human voice. Further, the predetermined sound is preferably output in a mode different from that of the horn sound so that the worker WK does not confuse the horn sound and the predetermined sound. In the illustrated example, the horn sound is a sound output from the horn device when the horn button HS is pressed. Specifically, the predetermined sound is output so as to be different from the horn sound in at least one of sound pressure, tone, and frequency. The notification to the outside may be implemented by the horn device as long as the horn device can output a predetermined sound that is a sound different from the horn sound. The notification to the outside may be implemented by activating the information transmission device G1. In particular, the notification to the outside may be implemented by causing the information transmission device G1 to emit light. Alternatively, in a case where the information transmission device G1 is a transmission device, the notification to the outside may be implemented by activating a mobile device such as a smartphone carried by the worker WK. Specifically, the notification to the outside may be implemented by causing the light emitting device such as a display screen of the mobile terminal to emit light in a predetermined manner, causing the mobile terminal to vibrate in a predetermined manner, or causing a sound output device such as a speaker or a buzzer attached to the mobile terminal to output sound in a predetermined manner. In this configuration, the worker WK can recognize that the operator OP is attempting to have a conversation by recognizing, for example, the light emission mode, the vibration mode, or the sound output mode of the light emitting device of the mobile terminal carried by the worker WK. In this way, the notification to the outside may be a visual notification, a tactile notification, or an auditory notification.

The elapsed time from the time point when the previous notification is performed is, for example, an elapsed time from the time point when the external sound output device SP1 outputs the latest predetermined sound. However, the elapsed time from the time point when the previous notification is performed may be the elapsed time from the time point when the external sound collection device M1 stops collecting a voice of a person (worker WK), the elapsed time from the time point when the internal sound collection device M2 stops collecting a voice of a person (operator OP), the elapsed time from the time point when the operator OP stops pressing the speech button KS, or the like.

When the controller 30 determines that it is not necessary to notify those on the outside that the operator OP is attempting to have a conversation (NO in step ST22), the controller 30 ends the conversation notification process of this time without giving any notification to the surroundings of the work machine 100. This is because the worker WK is considered to be still concentrating his/her attention on his/her ear when the worker WK has been having a conversation with the operator OP for the last time. This is also because it is considered that the worker WK feels annoyed if the notification is frequently performed in the middle of the conversation.

When the controller 30 determines that it is necessary to notify those on the outside that the operator OP is attempting to have a conversation (YES in step ST22), the controller 30 notifies those on the outside of the above fact (step ST23). In the illustrated example, the controller 30 outputs a control command to the external sound output device SP1, and causes the external sound output device SP1 to output a relatively high electronic sound such as “beep” for a predetermined time. The predetermined time is, for example, less than one second.

The worker WK who hears the predetermined sound can recognize that the operator OP is attempting to have a conversation. Therefore, the worker WK can concentrate his/her attention on his/her ear before the operator OP speaks, and can avoid missing the voice of the operator OP.

In the illustrated example, when the external sound output device SP1 outputs a predetermined sound, the controller 30 outputs a control command to each of the external sound collection device M1 and the internal sound collection device M2 so that the external sound collection device M1 does not collect a sound and the internal sound collection device M2 does not collect a sound. This is to reduce the occurrence of howling. However, the external sound collection device M1 may be configured to selectively not collect the predetermined sound while collecting sounds other than the predetermined sound when the external sound output device SP1 outputs the predetermined sound, or may be configured to remove a portion corresponding to the predetermined sound from the electric signal generated based on the collected sound. The same applies to the internal sound output device SP2.

With this configuration, the worker WK can know that the operator OP is attempting to have a conversation before the operator OP of the work machine 100 starts talking by hearing the predetermined sound. Therefore, the worker WK can smoothly proceed with the subsequent conversation without missing the voice of the operator OP at the start of the conversation. Even in a situation where a plurality of work machines are being activated in the same work site, the worker WK can easily recognize which operator of the work machine is attempting to have a conversation.

In the above-described example, the controller 30 is configured to be able to notify the worker WK that the operator OP of the work machine 100 is attempting to have a conversation with the worker WK around the work machine 100. However, the controller 30 may be configured to notify a person who is away from the work site that the operator OP is attempting to have a conversation with the person. For example, the controller 30 may be configured to notify the manager that the operator OP is attempting to have a conversation with the manager at a management center located away from the work site.

In the above example, the controller 30 is configured to notify those on the outside of the fact that the operator is attempting to have a conversation when the controller 30 determines that it is necessary to notify those on the outside of the above fact.

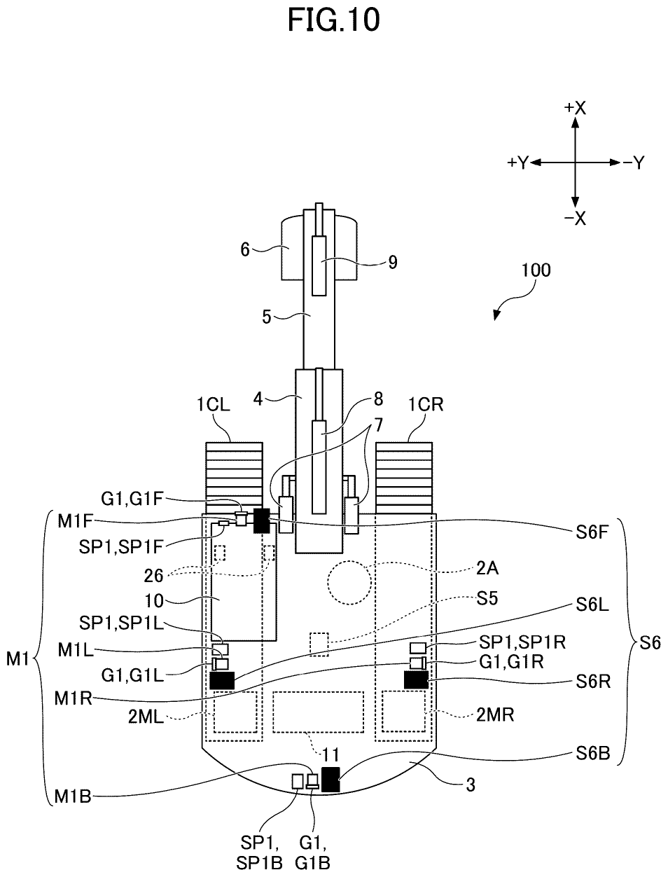

Next, another configuration example of a work machine 100 will be described with reference to FIG. 10. FIG. 10 is a top view illustrating another configuration example of the work machine 100. The work machine 100 illustrated in FIG. 10 is different from the work machine 100 illustrated in FIG. 1 in that the external sound output device SP1 is constituted by four speakers (a front speaker SP1F, a left speaker SP1L, a right speaker SPR, and a rear speaker SP1B). In the work machine 100 illustrated in FIG. 1, the external sound output device SP1 is configured by one omnidirectional speaker provided on the cabin 10.

With this configuration, the work machine 100 illustrated in FIG. 10 can output sound toward the worker WK in front of the work machine 100 without outputting sound toward workers WK on the left, right, and rear of the work machine 100 by turning on the front speaker SP1F (a state in which sound can be output) and turning off the left speaker SP1L, the right speaker SPR, and the rear speaker SP1B (a state in which sound cannot be output), for example.

In the example illustrated in FIG. 10, the front camera S6F and the front microphone M1F are provided adjacent to the front speaker SP1F, and a front light bar G1F is provided in the housing of the front microphone M1F. Further, a left camera S6L and a left microphone M1L are provided adjacent to the left speaker SP1L, and a left light bar G1L is provided in a housing of the left microphone M1L. Further, a right camera S6R and a right microphone M1R are provided adjacent to the right speaker SP1R, and a right light bar G1R is provided in a housing of the right microphone M1R. Further, a rear camera S6B and a rear microphone M1B are provided adjacent to the rear speaker SP1B, and a rear light bar G1B is provided in a housing of the rear microphone M1B.

With this configuration, the work machine 100 can turn on the light bar corresponding to the speaker that has been turned on (light emittable state), and turn off the light bar corresponding to the speaker that has been turned off (light unemittable state).

The external sound output device SP1 may be configured by one or a plurality of parametric speakers. Parametric speakers are ultrasonic speakers that can selectively transmit sound to people in a specific narrow range. Parametric speakers can transmit sound toward any location.

In the work machine 100 illustrated in FIG. 10, the controller 30 may detect the worker WK around the work machine 100 based on an image captured by the imaging device S6 and specify a position of the worker WK. Further, when a plurality of workers WK are present around the work machine 100, the controller 30 may discriminate between a conversation target person (a worker WK who is uttering voice) and a non-target person (a worker WK who is not uttering voice) based on the outputs of the four external sound collection devices M1. The controller 30 may distinguish between a conversation partner (the worker WK facing the work machine 100) and a non-partner (the worker WK not facing the work machine 100) based on the image captured by the imaging device S6. Then, the controller 30 may turn on the speaker and the light bar facing the worker WK. For example, when the worker WK (uttering voice) is present behind the work machine 100, the controller 30 may turn on the rear speaker SP1B while keeping the front speaker SP1F, the left speaker SP1L, and the right speaker SP1R turned off. In this case, the controller 30 may turn on the rear light bar G1B while keeping the front light bar G1F, the left light bar G1L, and the right light bar G1R turned off. Such a function may be implemented in the work machine 100 illustrated in FIGS. 1 to 5.

With this configuration, the controller 30 can output a sound in the direction in which the worker WK is present without outputting a sound in the direction in which the worker WK is absent. Therefore, the worker WK can easily recognize whether the worker WK is a conversation target person or a non-target person.

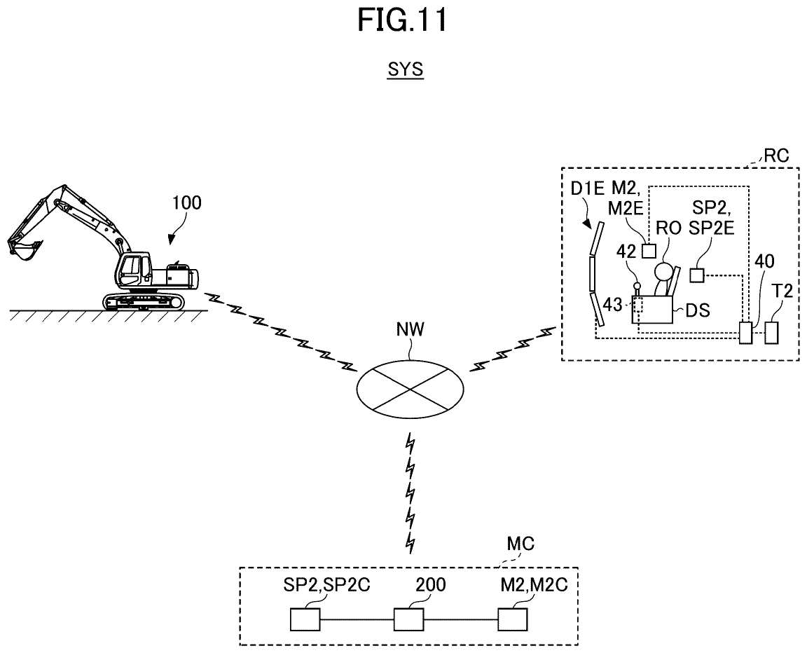

Next, a configuration example of the operation system SYS according to the embodiment of the present disclosure will be described with reference to FIG. 11. FIG. 11 is a schematic view illustrating a configuration example of the operation system SYS. As illustrated in FIG. 11, the operation system SYS includes the work machine 100, a remote control room RC, and a management center MC. Note that the detailed configuration of the work machine 100 is not illustrated in FIG. 11. This is because the work machine 100 illustrated in FIG. 11 has the same configuration as the work machine 100 illustrated in FIG. 1 or FIG. 10.

The work machine 100, the remote control room RC, and the management center MC are connected to each other via a communication network NW so as to be able to transmit and receive data. The work machine 100, the remote control room RC, and the management center MC may be connected to each other so as to be able to directly transmit and receive data to and from each other without passing through the communication network NW. In the illustrated example, the work machine 100 transmits information related to the work site to the remote control room RC. Thus, the remote operator RO in the remote control room RC can grasp the situation of the work site based on the information from the work machine 100.

The work machine 100 is provided with a sensor capable of three dimensionally recognizing the position and shape of an object existing in the work site. For example, the work machine 100 is provided with a space recognition device. Therefore, the work machine 100 can transmit a result of a three dimensionally measured work site to the remote control room RC.

The space recognition device is a device for recognizing a space around the work machine 100. In the illustrated example, the space recognition device is a LiDAR. The LiDAR measures, for example, a distance between the LiDAR and each of one million or more points within a monitoring range. The space recognition device may be any device that can measure the distance to an object. For example, the space recognition device may be a stereo camera, or may be a combination of the imaging device S6 and a distance measuring device such as a millimeter wave radar.

The number of work machines 100 included in the operation system SYS may be one or more. In the case where a plurality of work machines 100 are included, the remote operator RO of a specific work machine 100 can acquire information related to the work site acquired by the specific work machine 100 and additionally acquire information related to the work site acquired by another one or more other work machines 100.

The remote control room RC is provided with a communication device T2, a remote controller 40, an operation device 42, an operation sensor 43, a display device D1E, an internal sound collection device M2E, and an internal sound output device SP2E. In addition, an operation seat DS on which a remote operator RO who remotely operates the work machine 100 sits is installed in the remote control room RC.

The communication device T2 is configured to be able to communicate with the communication device T1 attached to the work machine 100.

The remote controller 40 is a computing device that executes various computations. In the present embodiment, the remote controller 40 is configured by a microcomputer including a CPU (Central Processing Unit) and a memory. The various functions of the remote controller 40 are implemented by the CPU executing programs stored in the memory.

The display device D1E is an device capable of displaying various kinds of information. The display device D1E displays an image based on information transmitted from the work machine 100 in order for the remote operator RO in the remote control room RC to visually recognize the surroundings of the work machine 100. In the illustrated example, the display device D1E is a liquid-crystal display that displays an image captured by the imaging device S6 mounted on the work machine 100. The display device D1E may be a display or a projector that implements naked-eye stereoscopic vision, or may be a virtual reality (VR) goggle or the like.

The internal sound output device SP2E is a device capable of outputting various kinds of sound information. The internal sound output device SP2E outputs sound based on information transmitted from the work machine 100 so that the remote operator RO in the remote control room RC can hear sound emitted at the work site. The internal sound output device SP2E may be configured to output a sound captured by the external sound collection device M1 attached to the outside of the cabin 10, or may be configured to output a sound captured by the internal sound collection device M2 attached to the inside of the cabin 10, for example. In this case, the internal sound collection device M2 may be provided at a position corresponding to the position of the ears of the operator seated in the operator's seat 50 in the cabin 10. The internal sound output device SP2E may be a stationary device such as a speaker, or may be a wearable device such as earphones or headphones. The speaker may be a monaural speaker, a stereo speaker, or a surround speaker. The speaker may be an omnidirectional speaker or a directional speaker. The wearable device may have a noise canceling function, a spatial audio function (stereophonic function), or a bone conduction function.

The operation device 42 is provided with the operation sensor 43 for detecting an operation content of the operation device 42. The operation sensor 43 is, for example, an inclination sensor that detects an inclination angle of the operation lever, an angle sensor that detects a slewing angle of the operation lever around a slewing axis, or the like. The operation sensor 43 may be configured by another sensor such as a pressure sensor, a current sensor, a voltage sensor, or a distance sensor. The operation sensor 43 outputs information related to the detected operation content of the operation device 42 to the remote controller 40. The remote controller 40 generates an operation signal based on the received information, and transmits the generated operation signal to the work machine 100. The operation sensor 43 may be configured to generate the operation signal. In this case, the operation sensor 43 may output the operation signal to the communication device T2 without passing through the remote controller 40. With such a configuration, the remote operator RO can remotely operate the work machine 100 from the remote control room RC.

The management center MC is a facility in which various devices for managing the work machine 100 at the work site or the remote operation of the work machine 100 by the remote operator RO in the remote control room RC are provided. In the illustrated example, the management center MC is installed at a position away from each of the work site of the work machine 100 and the remote control room RC. The management center MC is provided with a management device 200, an internal sound collection device M2C, and an internal sound output device SP2C.

The management device 200 is an example of a control device, and is, for example, a server computer (so-called cloud server) or an edge server. The management device 200 is typically a fixed terminal device, but may be a mobile terminal device (e.g., a laptop computer, a tablet, or a smartphone).

With this configuration, the manager in the management center MC can hear the sound emitted at the work site by using the sound collection device (the external sound collection device M1 or the internal sound collection device M2) attached to the work machine 100 and the internal sound output device SP2C, for example. The manager in the management center MC can hear the sound generated in the remote control room RC by using the internal sound collection device M2E and the internal sound output device SP2C provided in the remote control room RC, for example. Further, the manager at the management center MC can transmit his/her voice to the worker WK around the work machine 100 by using, for example, the internal sound collection device M2C and the external sound output device SP1 attached to the work machine 100. The manager at the management center MC can also use the internal sound collection device M2C and the internal sound output device SP2 attached to the work machine 100 to transmit his/her voice to the operator OP of the work machine 100. The manager in the management center MC can transmit his/her voice to the remote operator RO in the remote control room RC by using the internal sound collection device M2C and the internal sound output device SP2E provided in the remote control room RC.

As described above, the work machine 100 according to the embodiment of the present disclosure includes the cabin 10, the external sound collection device M1 disposed outside the cabin 10, the internal sound output device SP2 disposed inside the cabin 10, and the information transmission device G1 that enables the worker WK to recognize whether a voice of the worker WK around the work machine 100 has reached the operator OP of the work machine 100.

This configuration provides an effect that the information transmitted by the information transmission device G1 enables the worker WK to recognize that the voice of the worker WK around the work machine 100 has reached the operator OP of the work machine 100.

For example, when the information transmission device G1 is not mounted on the work machine 100, the worker WK cannot see the reaction of the operator OP who is hidden behind the upper slewing body 3 and cannot confirm whether or not his/her voice has reached the operator OP in a situation where the worker WK speaks to the operator OP from the behind of the work machine 100. In a situation where the worker WK cannot confirm whether or not his/her voice has reached the operator OP, the worker WK may erroneously considers that his/her voice has reached the operator OP. In this case, although the voice of the worker WK has not actually reached the operator OP, the worker WK may misunderstand that the operator OP is aware of the presence of the worker WK and may carelessly approach the work machine 100. In addition, when the operator OP is spoken by the worker WK, the operator OP notifies the worker WK of the fact that the operator OP has noticed the presence of the worker WK by a gesture, and thus the operator OP may interrupt the work. Therefore, a configuration in which the information transmission device G1 is not mounted on the work machine 100 may reduce the work performance of the work machine 100.

When the information transmission device G1 is mounted on the work machine 100, the worker WK behind the work machine 100 can check whether or not his/her own voice has reached the operator OP by looking at a light emission state of the information transmission device G1 (rear light bar G1B). Therefore, this configuration can prevent the occurrence of a situation in which the worker WK erroneously considers that his/her voice has reached the operator OP even though the voice of the worker WK has not actually reached the operator OP, and can prevent the worker WK from inadvertently approaching the work machine 100. Further, this configuration also makes it possible to prevent the operator OP from being forced to take his/her hand off the operation device 26 and interrupt the operation to perform a gesture.

The information transmission device G1 may be configured to be able to transmit an activation state of the information transmission device G1 to the worker WK. The activation state may include, for example, an ON state, an OFF state, a state in which the voice of the operator OP is being collected, or a state in which the voice of the operator OP is collectable. The state in which the voice of the operator OP is collectable is, for example, a state in which the operator OP presses the speech button KS.

With this configuration, the worker WK can accurately check various situations such as whether or not his/her voice is transmitted to the operator OP when the worker WK speaks to the operator OP, whether or not the operator OP is attempting to speak to the worker WK, and whether or not the operator OP is uttering a voice. Therefore, this configuration provides an advantageous effect of preventing a hindrance in conversations (conversations that are more difficult to communicate each other than face-to-face conversations) between the worker WK outside the cabin 10 and the operator OP inside the cabin 10.

The work machine 100 may include the internal sound collection device M2 disposed inside the cabin 10 and an external sound output device SP1 disposed outside the cabin 10.

This configuration provides an effect that the voice of the operator OP in the cabin 10 can be output toward the worker WK outside the cabin 10 at an appropriate volume. Therefore, this configuration eliminates the need for the operator OP to speak to the worker WK with a loud voice, and can reduce the burden on the operator OP when having a conversation with the worker WK.

The work machine 100 may include a speech button KS disposed in the cabin 10. The work machine 100 may be configured such that, when the speech button KS is pressed, the internal sound collection device M2 collects sound in the cabin 10, and the external sound output device SP1 outputs the sound collected by the internal sound collection device M2 toward the surroundings of the work machine 100.

This configuration can prevent the sound generated in the cabin 10 from being continuously output to the outside of the cabin 10 while allowing the operator OP to output his/her voice to the worker WK outside the cabin 10 as necessary, and thus can enhance the privacy of the operator OP.

The information transmission device G1 is preferably provided adjacent to the external sound collection device M1. This configuration provides an effect of enabling the worker WK to more easily recognize that the voice of the worker WK has reached the operator OP of the work machine 100. This is because the worker WK typically directs his/her eyes on the external sound collection device M1 when speaking toward the external sound collection device M1, and at this time, if the information transmission device G1 is adjacent to the external sound collection device M1, the information transmission device G1 naturally comes into the eyes.

The operation system SYS according to the embodiment of the present disclosure includes the external sound collection device M1 attached to the work machine 100, an internal sound output device SP2 (internal sound output device SP2E) that outputs sound to the operator OP (remote operator RO) of the work machine 100, and the information transmission device G1 that enables the worker WK to recognize whether the voice of the worker WK around the work machine 100 has reached the operator OP (remote operator RO).

This configuration provides an effect that the information transmitted by the information transmission device G1 enables the worker WK to recognize that the voice of the worker WK around the work machine 100 has reached the operator OP. This configuration also provides an effect that even when the work machine 100 is remotely controlled, the information transmitted by the information transmission device G1 enables the worker WK to recognize that the voice of the worker WK around the work machine 100 has reached the remote operator RO.

The work machine 100 according to the embodiment of the present disclosure includes the internal sound collection device M2 that collects a voice of the operator OP of the work machine 100, the external sound output device SP1 attached to the work machine 100, and the controller 30 as a control device that detects that the operator OP of the work machine 100 is attempting to have a conversation with a person (worker WK) around the work machine 100 using the internal sound collection device M2 and the external sound output device SP1 and notifies the surroundings of the work machine 100 of the detection fact.

This configuration provides an effect that the worker WK can recognize that the operator OP of the work machine 100 is attempting to speak to the worker WK. In this configuration, even in a situation where a plurality of work machines are activating at the work site, the worker WK can recognize which operator of the work machine is attempting to speak to the worker WK. In this configuration, the worker WK can recognize that the operator OP is attempting to speak to the worker WK before the operator OP utters. Therefore, this configuration can prevent the worker WK from speaking at the same timing as the timing at which the operator OP speaks. Therefore, the worker WK can speak at a timing different from the timing at which the operator OP speaks.

The controller 30 may be configured to be able to audibly, tactually, or visually notify a person around the work machine 100 that the operator OP of the work machine 100 is attempting to have a conversation with a person around the work machine 100 (the worker WK) before the operator OP of the work machine 100 utters or during the utterance of the operator OP of the work machine 100.

This configuration provides an effect that the operator OP can notify the worker WK at an appropriate timing that the operator OP is attempting to speak to the worker WK.

The work machine 100 may include a speech button KS disposed in the cabin 10. In this case, when the speech button KS is pressed, the internal sound collection device M2 may collect sound in the cabin 10, and the external sound output device SP1 may output the sound collected by the internal sound collection device M2 toward the surroundings of the work machine 100. Then, when the speech button KS is pressed, the controller 30 may notify those on the outside of the cabin 10 that the operator OP of the work machine 100 is attempting to have a conversation with a person (worker WK) outside the cabin 10.

This configuration provides an effect that the operator OP can make the worker WK recognize that the operator OP is about to speak to the worker WK.

The controller 30 may be configured not to perform notification until a predetermined time elapses after the previous notification is performed. For example, the controller 30 may be configured not to perform the auditory notification until a predetermined time elapses after the previous auditory notification is performed.

This configuration provides an effect of preventing the notification from being frequently performed and causing the worker WK to feel bothersome. However, the controller 30 may be configured to output at least one of the visual notification and the tactile notification even when the predetermined time has not elapsed after the previous notification. This is because the visual notification and the tactile notification are less likely to cause the worker WK to feel bothersome than the auditory notification even if the visual notification and the tactile notification are frequently output.

Further, the notification to the surroundings of the work machine 100 may be implemented by outputting a predetermined sound. In this case, the predetermined sound is preferably a sound distinguished from the horn sound.

This configuration provides an effect that the operator OP can notify the worker WK that the operator OP is attempting to have a conversation with the worker WK without outputting a horn sound having a high effect of attracting attention, that is, without excessively attracting attention of a person around the work machine 100.

The work machine 100 may include the internal sound output device SP2 disposed inside the cabin 10 and the external sound collection device M1 disposed outside the cabin 10.

This configuration provides an effect that the voice uttered by the worker WK can be more reliably transmitted to the operator OP after the operator OP notifies the worker WK that the operator OP is attempting to have a conversation with the worker WK. This is because the voice of the worker WK collected by the external sound collection device M1 is reproduced by the internal sound output device SP2.

Further, the controller 30 may be configured to disable the internal sound collection device M2 from collecting sound related to the auditory notification when the auditory notification is being performed. For example, the controller 30 may turn off the internal sound collection device M2 (a state in which sound collection is not possible) when an auditory notification is being made.

This configuration provides an effect of preventing the occurrence of howling. In particular, this configuration provides an effect that it is possible to prevent the sound (auditory notification) output by the external sound output device SP1 from being collected by the internal sound collection device M2 and further the sound (auditory notification) collected by the internal sound collection device M2 from being output by the external sound output device SP1.

The work machine 100 may include a human detection device that detects a human around the work machine 100. The human detection device may be configured by the imaging device S6, LiDAR, or the like. In this case, the controller 30 may be configured to, when detecting that the operator OP of the work machine 100 is attempting to have a conversation with a person (worker WK) around the work machine 100, identify the position of the person around the work machine 100 based on the output of the human detection device and notify the operator OP of the fact (i.e., the fact that the operator OP of the work machine 100 is attempting to have a conversation with a person (worker WK) around the work machine 100) in the direction in which the person (worker WK) is present.

This configuration provides an effect that the specific worker WK can be notified that the operator OP is attempting to speak. That is, this configuration provides an effect that the specific worker WK can be notified that the operator OP is attempting to speak without attracting attention of a person other than the specific worker WK.

The controller 30 may be configured to output a sound toward the direction in which the person (worker WK) is present, or to cause the light emitter to emit light toward the direction in which the person (worker WK) is present.

This configuration provides an effect that the specific worker WK can be more reliably notified that the operator OP is attempting to speak.

The operation system SYS according to the embodiment of the present disclosure includes the internal sound collection device M2 (internal sound collection device M2E) that collects voices of the operator OP (remote operator RO) of the work machine 100, the external sound output device SP1 attached to the work machine 100, and the controller 30 as a control device that detects that the operator OP (remote operator RO) of the work machine 100 is attempting to have a conversation with a person (worker WK) around the work machine 100 using the internal sound collection device M2 (internal sound collection device M2E) and the external sound output device SP1 and notifies the surroundings of the work machine 100 of the detection.

This configuration provides an effect of enabling the worker WK to recognize that the operator OP of the work machine 100 is attempting to speak to the worker WK. This configuration also provides an effect of enabling the worker WK toc recognize that the remote operator RO of the work machine 100 is attempting to speak to the worker WK.

The preferred embodiments of the present disclosure have been described above. However, the invention according to the present disclosure is not limited to the above-described embodiments. Various modifications, substitutions, and the like can be applied to the above-described embodiments without departing from the scope of the invention according to the present disclosure. Further, the features described with reference to the above-described embodiments may be appropriately combined as long as there is no technical contradiction.

What is claimed is:

1. A work machine comprising:
a lower traveling body;
an upper slewing body slewably mounted on the lower traveling body;
an external microphone configured to collect sound around a work machine;
an internal speaker configured to output sound to an operator of the work machine;
an information transmission device configured to enable a worker around the work machine to recognize whether or not a voice of the worker has reached the operator of the work machine; and
a processor, and a memory storing instructions that cause the processor to execute a process, wherein the process includes
collecting, by the external microphone, sound around the work machine;
outputting, by the internal speaker, the sound to the operator of the work machine; and
enabling, by the information transmission device, the worker around the work machine to recognize whether or not a voice of the worker has reached the operator of the work machine.

2. The work machine according to claim 1,
wherein the enabling includes transmitting an activation state of the information transmission device to the worker, and
wherein the activation state includes an ON state, an OFF state, a state in which a voice of the operator of the work machine is collected, or a state in which the voice of the operator of the work machine is collectable.

3. The work machine according to claim 1, further comprising:
an internal microphone configured to collect a voice of the operator of the work machine; and
an external speaker configured to output sound toward surroundings of the work machine,
wherein the process further includes
collecting, by the internal microphone, a voice of the operator of the work machine; and
outputting, by the external speaker, the sound toward the surroundings of the work machine.

4. The work machine according to claim 3, further comprising:
a speech button, wherein the internal microphone collects sound when the speech button is pressed, and the external speaker outputs the sound collected by the internal microphone toward the surroundings of the work machine.

5. The work machine according to claim 1, wherein the information transmission device is provided adjacent to the external microphone.

6. An operation system for a work machine, the operation system comprising:
an external microphone configured to collect sound around a work machine;
an internal speaker configured to output sound to an operator of the work machine;
an information transmission device configured to enable a worker around the work machine to recognize whether or not a voice of the worker has reached the operator of the work machine; and
a processor, and a memory storing instructions that cause the processor to execute a process, wherein the process includes
collecting, by the external microphone, sound around the work machine;
outputting, by the internal speaker, the sound to the operator of the work machine; and
enabling, by the information transmission device, the worker around the work machine to recognize whether or not a voice of the worker has reached the operator of the work machine.
